(19) United States
(12) Patent Application Publication
(10) Pub. No.: US 2007/0226200 A1
(43) Pub. Date: Sep. 27, 2007

(54) Grouping and regrouping using aggregation

(75) Inventors: Christopher Alan Hays, Monroe, WA (US); Robert M. Bruckner, Redmond, WA (US)

Correspondence Address: WOODCOCK WASHBURN LLP (MICROSOFT CORPORATION), CIRA CENTRE, 12TH FLOOR, 2929 ARCH STREET, PHILADELPHIA, PA, 19104-2891, US

(73) Assignee: Microsoft Corporation, Redmond, WA (US)

(21) Appl. No.: 11/386,423

(22) Filed: Mar. 22, 2006

(51) Int. Cl. G06F 17/30

(52) U.S. Cl. 707/4

(57) ABSTRACT

Grouping and regrouping of data using aggregation is disclosed. In one aspect of this disclosure, data can be grouped based on some expressions, and then this result can be regrouped based on other expressions which may utilize aggregates computed in the context of the first group. Such regrouping is performed on a group basis—as opposed to being regrouped, for example, on a row basis. The grouping and regrouping can employ various logical expressions that may incorporate the aggregates. Moreover, regrouping of regrouping can be performed, and the mentioned logical expressions can be based on groups of various scopes.

### FIELD OF TECHNOLOGY

The present subject matter relates to the field of computing, and more particularly, to databases, although databases are merely an exemplary and non-limiting field of the presently disclosed subject matter.

### BACKGROUND

When reporting data, there are commonly cases where the data needs to be grouped and aggregated to be useful. For example, when reporting on sales for a company, a mere list of every transaction does little good to a CEO when making business decisions. By grouping and aggregating the data into meaningful categories (for example, total sales broken down by product and region), data is transformed into information on which action can be taken.

Occasionally, however, straightforward grouping and aggregation may be insufficient. This is particularly a common problem when the bulk of the data falls into a smaller number of categories, but there exists a large number of additional categories which contain small amounts of data. Simply neglecting this “long tail” of data may result in incorrect decisions (or at minimum, it may result in grand totals which appear to be different than the sum of their parts). What is needed is a mechanism by which categories themselves can be re-categorized based on aggregate information about the category as a whole. For example, mechanisms are needed so that users of data can easily achieve such goals as: sorting products into large, medium, and small volume buckets; grouping all customers who ordered fewer than X products into an “infrequent customer” bucket—while listing the others individually; or, conversely, listing the top 10 customers individually, but grouping all the rest into an “other” category, and so on.

### SUMMARY

Mechanisms are provided herein for grouping and regrouping data using aggregation. In one aspect of the present disclosure, a grouping module is used for grouping data into at least one group instance, where the grouping module groups the data using at least one grouping expression. Additionally, a regrouping module is used for regrouping group instances, where the regrouping module regroups the group instances on a group instance by group instance basis into at least one regrouped group instance, using the at least one regrouping expression. Such grouping and regrouping avoids the problem—specially endemic to databases—where grouping can only be performed on a row-by-row basis.

Furthermore, the regrouping expression can use aggregates, such as sum, average, minimum or maximum values of a data set. Interestingly, the regrouping module can perform regrouping based in part on an aggregate computed within a group of higher scope than the group, based in part on an aggregate computed within a group of the same scope as the group, on a scalar value, or just about any logical construct. Finally, such regrouping can be performed multiple times, such that regrouped groups can be further regrouped.

It should be noted that this Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The foregoing Summary, as well as the following Detailed Description, is better understood when read in conjunction with the appended drawings. In order to illustrate the present disclosure, various aspects of the disclosure are shown. However, the disclosure is not limited to the specific aspects discussed. The following figures are included:

FIG. 1 illustrates an exemplary framework for grouping and regrouping using aggregation;

FIG. 2A illustrates a simple grouping mechanism that groups and aggregates data on a per-row basis;

FIG. 2B illustrates, in contrast to FIG. 2A, an alternative mechanism that groups and aggregates data on both a per-row and a per-group basis;

FIG. 3A illustrates a typical table that might be subject to a grouping and aggregation of its data;

FIG. 3B illustrates the table of FIG. 3A that has been grouped based on a category;

FIG. 3C illustrates the table of FIG. 3B that has been grouped and aggregated;

FIG. 3D illustrates the notion of grouping by pass or failure status;

FIG. 3E illustrates the notion of aggregating the table of FIG. 3D;

FIG. 4A illustrates a slightly more complicated example than in FIG. 3A, again showing a typical table that might be subject to a grouping and aggregation of its data;

FIG. 4B illustrates how the table of FIG. 4A that has been grouped based on some category and aggregated;

FIG. 4C illustrates conceptually how the data in the table of FIG. 4B can be regrouped (and regrouped again) based on the aggregations of the table;

FIG. 4D illustrates in a table how the data in the table of FIG. 4B can be regrouped based on the aggregations of the table;

FIG. 5 illustrates one exemplary system implementation of the presently disclosed subject matter in a block flow chart;

FIG. 6 illustrates another exemplary implementation in a block flow chart, although this time in method form; and

FIG. 7 illustrates the notion that the presently disclosed subject matter could be implemented just about in any type of medium, such as computer readable medium.

### DETAILED DESCRIPTION

An Exemplary Framework For Grouping And Regrouping Using Aggregation

In one aspect of the presently disclosed subject matter, a general and exemplary (and hence non-limiting) framework can be used to provide context for the discussion to follow. In this aspect, each group may contain a list of grouping expressions by which to group data. Additionally, a second set of grouping expressions may be added, which, if present, may be used to group the groups themselves. Such expressions may be referred to as “regrouping expressions.” Unlike the grouping expressions, the regrouping expressions may contain aggregate functions, and those aggregate functions may (and typically can) refer to aggregates calculated within a current grouping scope or any containing scope. It should also be noted, the term “aggregate” is not limited to only summing functionalities, but rather includes a variety of other functionalities, such as determining a maximum of a set of data, a minimum of a set of data, and so on. Those of skill in the art will readily appreciate the numerous applications of an “aggregate” functionality.

For example, a report may contain data on products and sales of those products. A user may wish to show total sales by product, but place all products with less than 10% of the total sales into a group called “Other”. To do so, the grouping expressions can group the data based on product identification (“ProductID”), and the regrouping expressions can regroup the initial groups based on calculations that return either the “ProductID” or the “Other” category, where the regrouping can be based on whether the total sales for the initial grouping was less than 10% of the total sales.

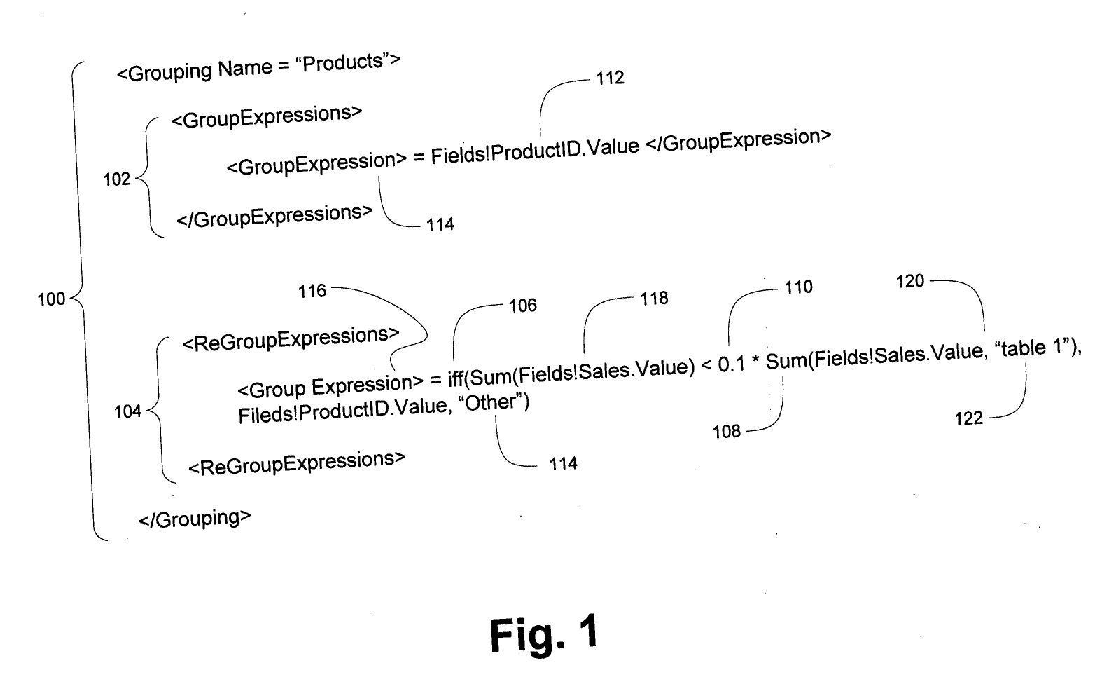

FIG. 1 illustrates an exemplary definition 100 for grouping 102 and regrouping 104 using an exemplary markup language. The definition 100 as a whole may contain two sections, where the first section defines the grouping 102 function and the second section defines the regrouping 104 function. Within the first grouping section 102, data may be grouped based on some group expression 114. In FIG. 1, this expression 114 is based on product identification (“ProductID” 112). Once this grouping 102 is performed, the second regrouping 104 section can be performed.

In the regrouping section 104, a regrouping expression 116 can contain some aggregate functionality, such as “sum” 108, and use this functionality to perform some logical functionality, such as “iff” (if and only if) 106. Thus, per the products and sales example discussed above, the algorithm 100 can first group 102 data based on “ProductID” 112 using some grouping expression 114, and then regroup 104 these results based on some logical regrouping expression 116. Interestingly, the regrouping expression 116 may use an aggregate functionality 108, where this aggregate functionality 108 can refer to aggregates calculated within a current grouping scope 118, or any containing scope 120. The current grouping scope 118 can refer to the underlying grouping 102 (“Fields!Sales.Value”), whereas the containing grouping scope can refer to the all encompassing scope for all the data which may be stored in some table (“Fields!Sales.Value, ‘table 1’”). In fact, any scope in between the grouping scope 118 and the all encompassing scope 120 can be used by the regrouping expression 116.

Thus, in the regrouping expression 116, a group of a certain product is placed in an “Other” group 114 if and only if 106 its sum is less than 10% 110 of the total sales in some table 122 containing all the sales. This example provides a very simple and non-limiting scenario that demonstrates how grouping and regrouping may work, and those of skill in the art will readily appreciate more complex scenarios that may employ this algorithm 100.

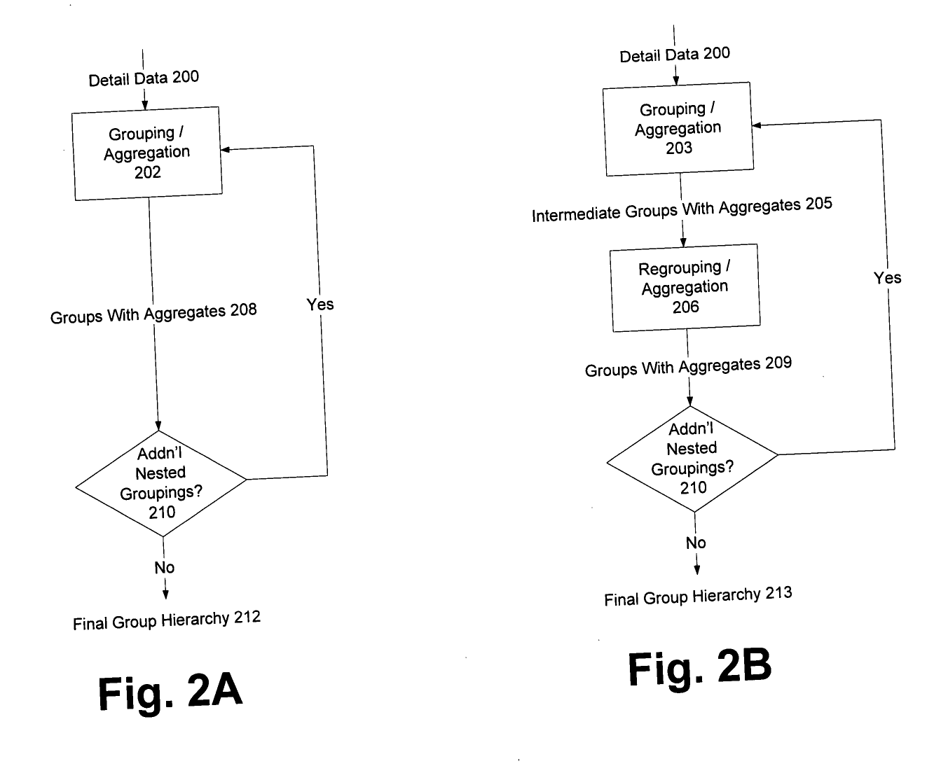

FIGS. 2A and 2B highlight the difference between a simple grouping mechanism (FIG. 2A), on the one hand, and on the other the grouping and regrouping mechanism discussed with reference to FIG. 1. Specifically, FIG. 2A illustrates a simple grouping mechanism, where grouping 202 can be performed with aggregation. This type of grouping can be performed, for example, on a table containing some data 200. Moreover, this type of grouping is performed on a row-by-row basis of the table. Thus, each row can be individually examined, and then once this is performed, the rows can be aggregated and grouped 202. The result 208 of this function 202 can then be passed to a decision module 210, which may inquire if any additional row-by-row groupings are to performed—which may be nested groupings. If the answer is “yes,” this grouping mechanisms feeds back to the grouping aggregation 202 module. If the answer is “no,” then a final group hierarchy 212 is established.

In the former case, upon feedback, additional grouping 202 is again performed on a row-by-row basis. Groups with aggregates 208 are thus again passed down to the decision module 210, and so on. The net effect of this type of mechanism is that groupings, such as nested groupings, are always performed on a row-by-row basis. One reason for this limitation is that it is difficult, at least from a development and coding point of view, to do anything other than row-by-row grouping and aggregating.

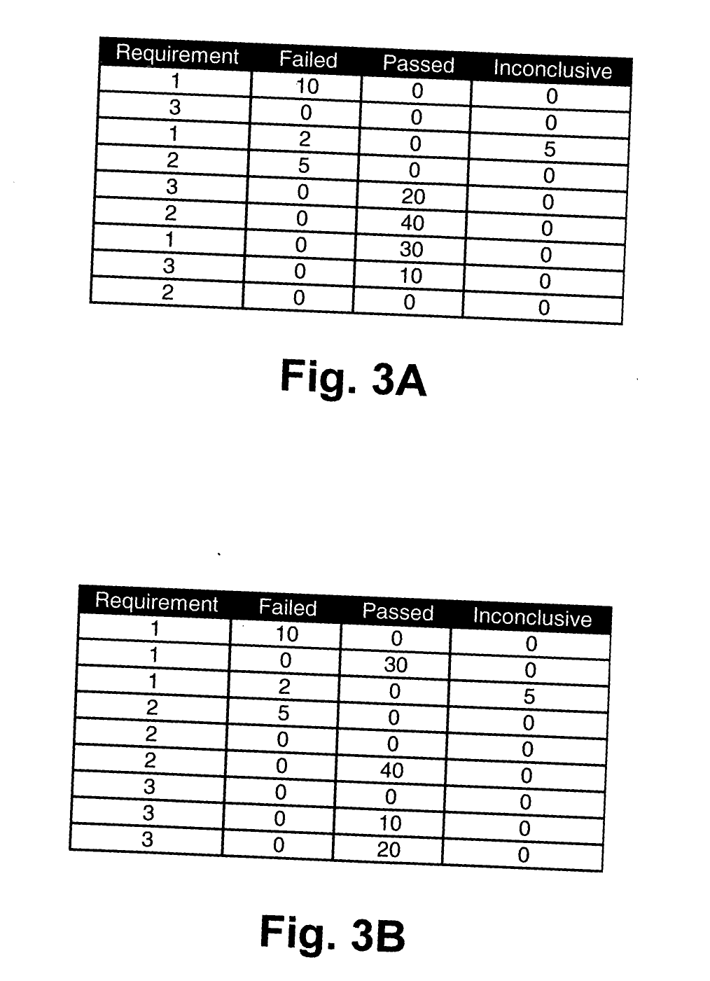

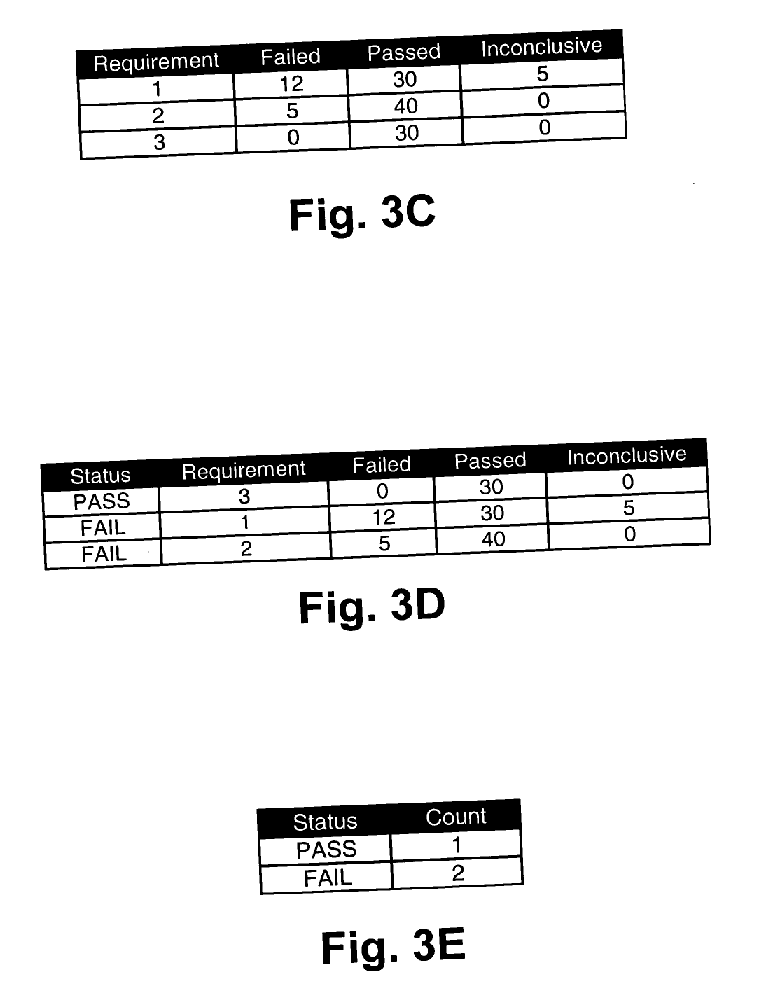

In contrast to this mechanism of FIG. 2A, FIG. 2B illustrates the distinct notion of regrouping of groups. Just as in FIG. 2A, in FIG. 2B data 200, such as a table, is provided. The grouping module 203 here can arrange data into groups. Once the data is arranged, aggregation functions can be applied. This results in intermediate groups with aggregates 205. Importantly, the intermediate groups 205 that were formed, can then be regrouped by a regrouping module 206, without needing to regroup data on a row-by-row basis (instead, regrouping groups). One reason why such regrouping of groups may be desirable (instead of rows) is that some calculations cannot be performed on a per row basis, but rather may have to be performed on groups—as will be seen below, in FIGS. 3A and 3B.

The looping mechanism in FIG. 2B is otherwise similar to that described in FIG. 2A. After the regrouping module 206 has performed its function, it can send the regrouped groups 209 to a decision module 211, which asks whether to perform additional regroupings. If the answer is “yes,” the regrouped groups can get regrouped once again, and so on. Such nested grouping can be performed to arbitrary depth. Any aggregation that is involved in any regrouping can be based on the original grouping or any intermediate grouping (i.e. a grouping with a higher scope). Conversely, if the answer is “no,” a final group hierarchy 213 can be established.

Aspects of Exemplary Uses For Grouping And Regrouping Using Aggregation

With FIGS. 1, 2A, and 2B serving as a conceptual framework, FIGS. 3A, 3B and 3C present one exemplary instance of the notion of grouping and regrouping using aggregation. First, FIG. 3A illustrates a typical table that might be subject to grouping. In the table of FIG. 3A, the first column specifies a “Requirement” field, which may correspond to a type of test to be performed. Thus, a first (“1”) requirement is listed in the first row of the table; a second (“2”) requirement is listed in the fourth row; and a third requirement (“3”) is listed in the second row. It should be noted that the first requirement, for example, is not only listed in the first row but also in the third row and the seventh row (the other two requirements are also listed several times, as can be plainly seen).

Next, FIG. 3B illustrates that this table can be grouped based on some category, such as the “Requirement” category (as was mentioned above with reference to FIG. 1, grouping expressions can perform this type of grouping). Thus, now, in FIG. 3B, the table is arranged so that all the entries of the first requirement appear together, all the entries of the second requirement appear together, and all the entries of the third requirement appear together. As can be seen from the table, in the first row, the first requirement has failed 10 times, passed 0 times, and has been inconclusive 0 times. In the second row, the first requirement has failed 0 times, passed 30 times, and has been inconclusive 0 times. Finally, in the third row, the first requirement failed 2 times, passed 0 times, and has been inconclusive 0 times, and so on, with the other two requirements.

One exemplary aggregation that can be performed on this table is summation. Hence, with respect to the first requirement, it can be seen that it failed a total of 12 times, passed a total of 30 times, and has been inconclusive a total 5 times. One difficulty that the table of FIG. 3B presents, is that a determination cannot be made whether the first requirement passed all tests just by looking at the table on a per-row basis. In other words, such a determination cannot be made just by examining the first row, or by just examining the second row, or the third row, and so on. Instead, an aggregation must first be performed in order to determine what the total number of failures, passes, and inconclusions resulted. Once the aggregation is performed (as seen in FIG. 3C), the results of this aggregation can subsequently be used as the basis for regrouping. For example, by grouping into requirements with zero failures (i.e. the requirements which “passed”) versus the requirements with at least 1 failure (i.e. the requirements which “failed”), the grouped result would be as shown in FIG. 3D. Aggregating this result (using a “Count” aggregate function) would result in the table shown in FIG. 3E, which shows a count of passed and failed requirements.

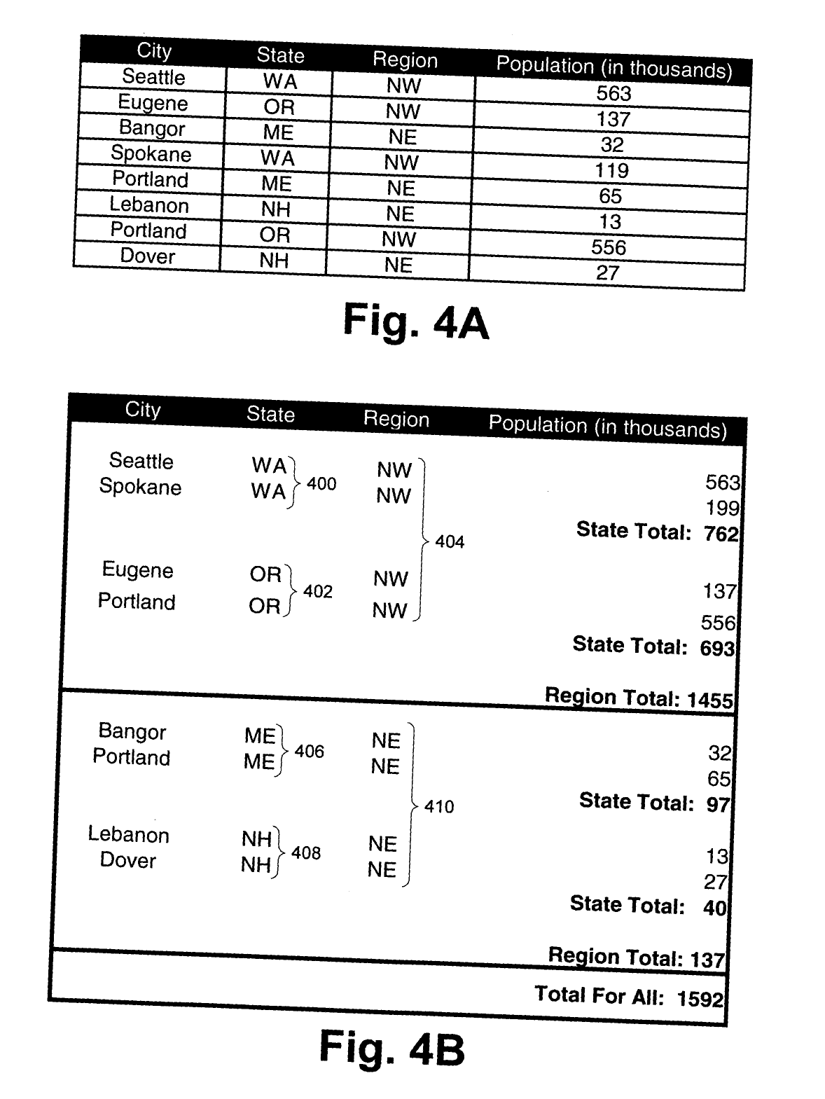

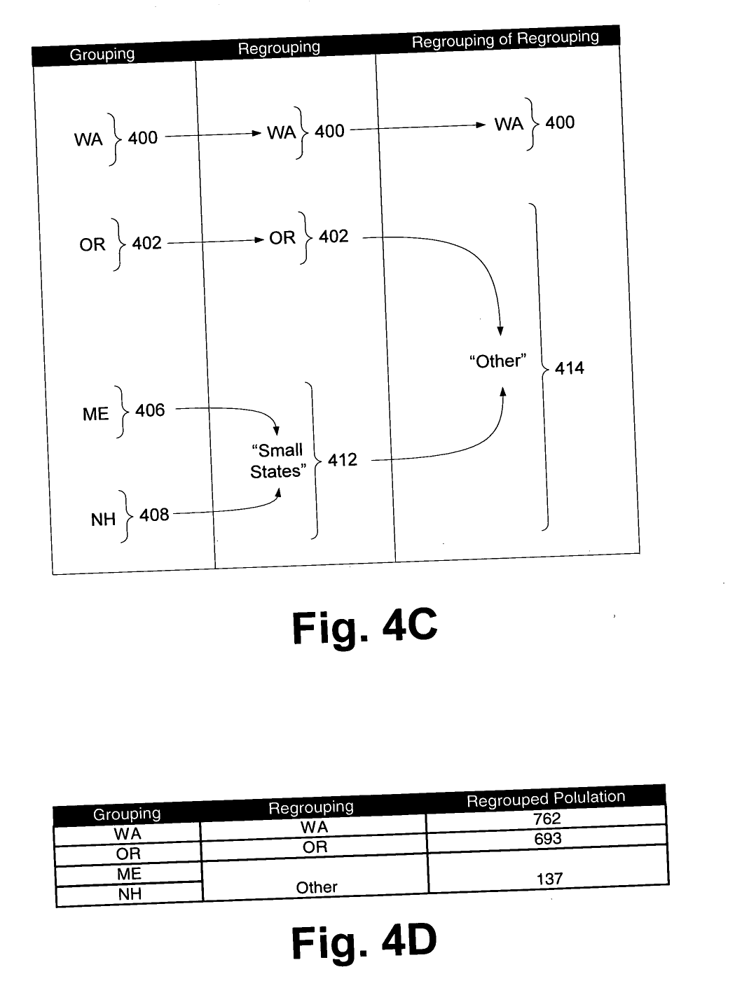

FIGS. 4A, 4B, and 4C illustrate a slightly more complicated example of grouping and regrouping that further fleshes out the concepts discussed so far, especially with reference to FIGS. 1 and 2. FIG. 4A illustrates a typical table with data. In the first row, the city of Seattle is located in the state of Washington (“WA”), and the state of Washington is located in the Northwest region (“NW”). The population of Seattle is 563,000. Similar logic applies to the same cities, states, regions, and the corresponding city populations. It should be noted that the table of FIG. 4A is merely exemplary, and additional cities could be included (or all cities) in any given state.

Next, in FIG. 4B, the data in table of FIG. 4A has been grouped and aggregated, so that then it can be regrouped (in FIG. 4C) based on some regroup expression. Thus, the first state grouping is WA 400, the second is OR 402, the third is ME 406, and the fourth is NH 408. It should be noted, however, that even though the grouping expression applied to FIG. 4A was based on state groupings, it could just as easily have been performed based on regional groupings—namely, NW 404 and NE 410, and so on. Furthermore, the aggregate values are also provided in the table: WA has a total of 762,000 people, based on the cities of Seattle and Spokane (obviously, more than two cities could be used, but this table is merely exemplary); Oregon has a total of 693,000 people, based on the cities of Eugene and Portland, and so on.

Now, in FIG. 4C, based on the aggregates performed in FIG. 4B, various regroupings can be performed. For example, a regrouping expression can use a scalar value to regroups the groups of states 400, 402, 406, and 408. The regrouping expression can require that any state group that is greater than the scalar value remain as its own group, but any state group that is less than the scalar value be placed into a group designated as “other.” In this example, the regrouping can help users distinguish, for instance, state groups with large populations from state groups with small populations.

This scenario is conceptually shown in FIG. 4C. The scalar value can be, for example, 100,000, and the regrouping expression can require that any state group with a lower population than 100,000 be placed in a “Small States” group. Per the table of FIG. 4B, the WA group 400 has a population total of 769,000; the OR group 402 has a population of 693,000; the ME group has a population of 97,000; and the NH has a population of 40,000. Thus, FIG. 4C shows in the “Regrouping” column of the table that the regrouping expression would leave the WA group 400 and the OR group 402 in the state they were before the regrouping, but would place the ME group 406 and the NH group 408 in a “Small States” group 412. Importantly, the regrouping is based on groups 400, 402, 406, 408 of data, not individual table rows (as those shown in FIG. 4A). The regrouping with the grouped populations is shown in table in FIG. 4D.

Furthermore, the regrouped groups can be regrouped again, as shown in the “Regrouping of Regrouping” column of the table in FIG. 4C. A regrouping of regrouping expression could require, for example, that any state group that is at least 45% of the total population be left in its own group, but any state group that is less than this value be placed in an “Other” group 414. Per FIG. 4B, this 45% of the total would be equal to 716,400 (45% of the total of 1,592,000), which would mean that the WA group 400 (population 762,000) would again be left to itself, but the “Small States” group 412 (population 137,000) and the OR group 402 (population 693,000) would be placed in the “Other” group 414. As those of skill in the art will appreciate, such grouping, regrouping, re-regrouping, can be performed indefinitely.

One important conclusion to draw from the examples discussed in FIGS. 4A-4D is that regrouping is performed based on group instances, and such regrouping can be based on aggregate values of groups of varying scope. This means that state groups can be regrouped based on other state groups (thus having a current scope), regional groups (having an intermediate scope), or even the total group (having the largest scope, as was shown when using the total population value: 1,592,000). Of course, this much is apparent from considering the general algorithm shown in text form in FIG. 1, and illustrated in schematic form in FIG. 2.

Aspects of An Exemplary Implementation For Grouping And Regrouping Using Aggregation

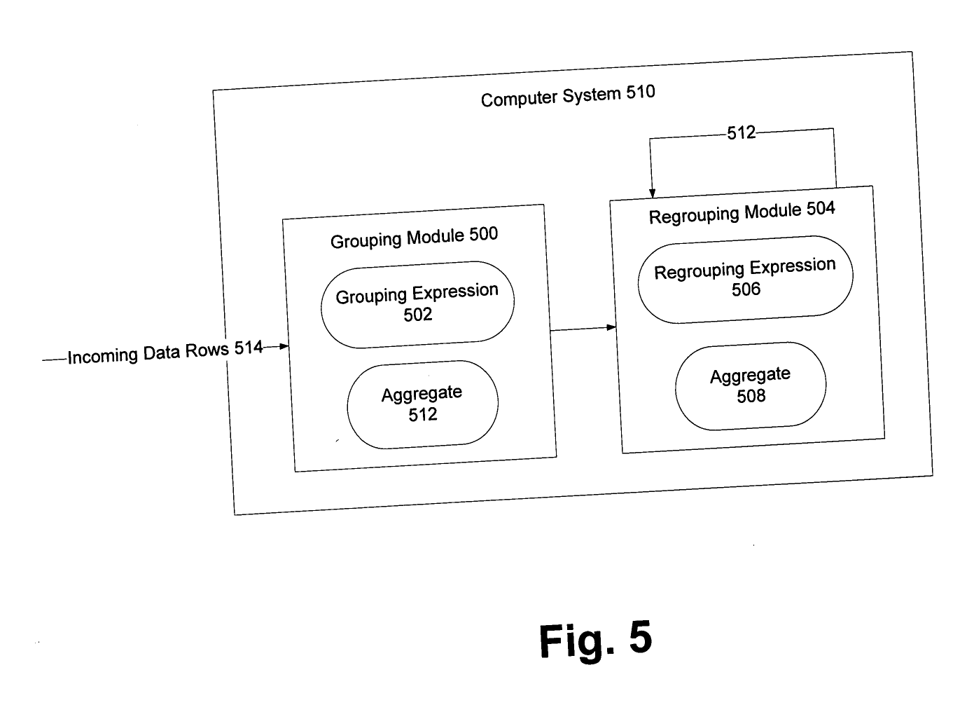

The presently disclosed subject matter lends itself to various implementations. In one exemplary implementation, FIG. 5 illustrates a system for grouping and regrouping data using aggregation. A computer system (which, for instance, could be a database system—but is not so limited) is illustrated, with a grouping module 500 for grouping data into at least one group instance, where the grouping module groups the data using at least one grouping expression 502. Moreover, the database system 510 also can contain a regrouping module 504 for regrouping the group instances, where the regrouping module 504 regroups the group instances on a group instance by group instance basis into at least one regrouped group instance, using at least one regrouping expression 506.

It can also be seen that the regrouping expressions 506 may use one or more aggregates 512. In this system, the regrouping module 504 may perform regrouping based in part on an aggregate computed within a group of higher scope than the original group, as was explained with reference to FIGS. 4A-4D. Alternatively, the regrouping module 504 can perform regrouping based in part on an aggregate computed within a group of the same scope as the original group, or it may even perform regrouping based on a scalar value, as was shown in the example above. Lastly, the feedback mechanism 512 allows the system to regroup the at least one regrouped group.

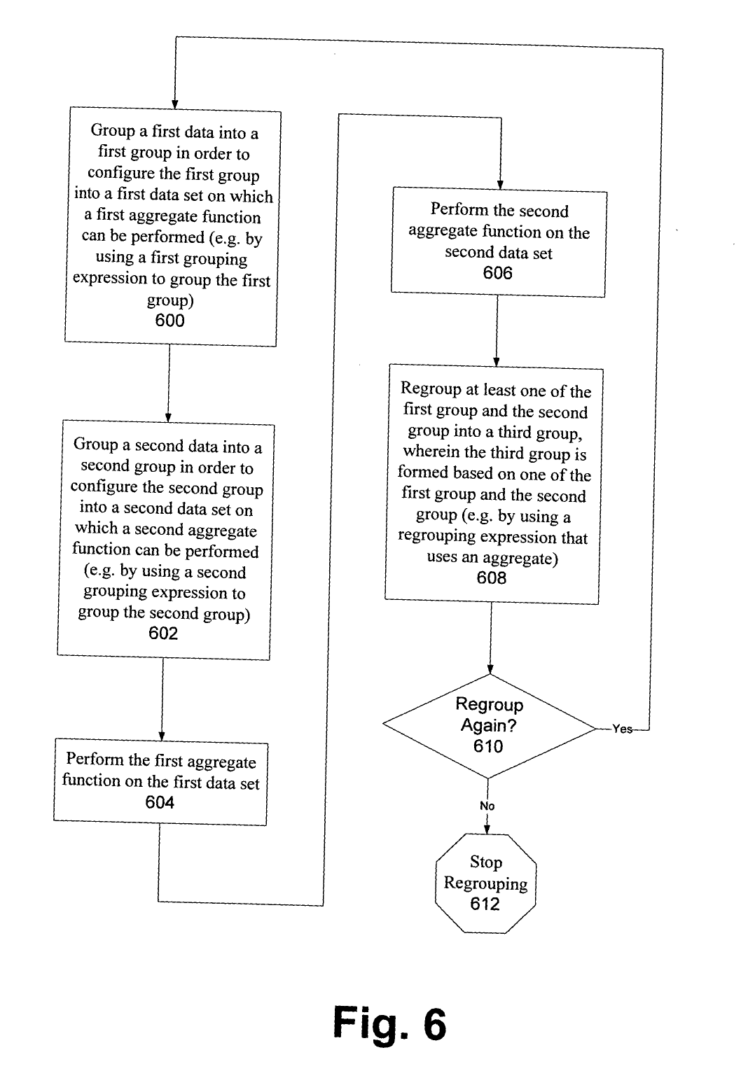

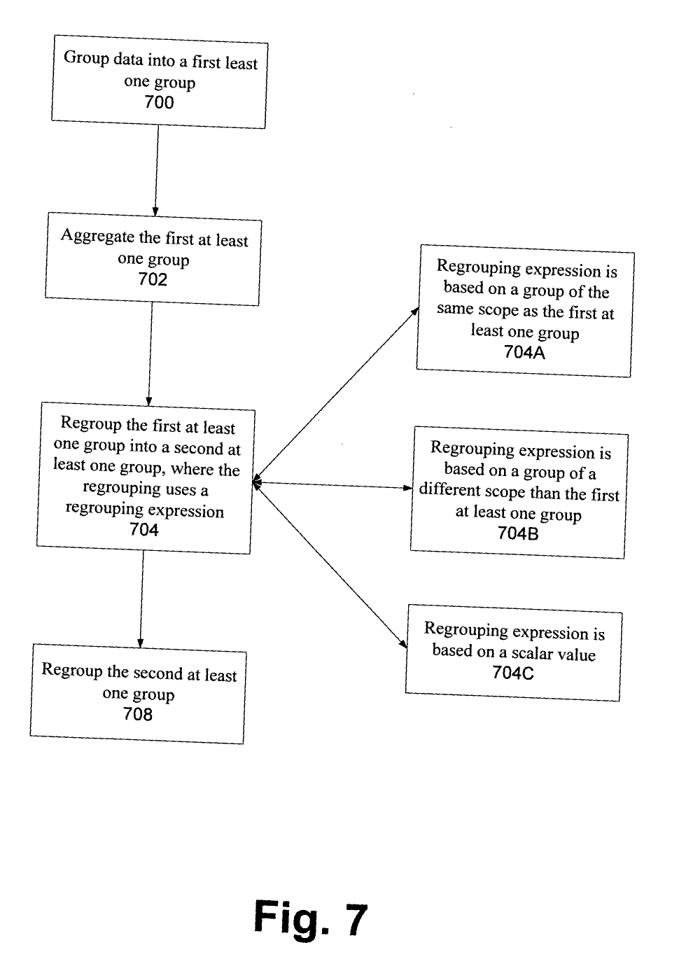

Next, FIG. 6 illustrates an exemplary method implementation of the presently disclosed subject matter. At block 600, a first data is grouped into a first group in order to configure the first group into a first data set on which a first aggregate function can be performed. Then, at block 602, a second data is grouped into a second group in order to configure the second group into a second data set on which a second aggregate function can be performed. Once this is done, at blocks 604 and 606, the first aggregate function is performed on the first data set, and the second aggregate function is performed on the second data, respectively. It should be noted that the order of the steps depicted in the blocks is not necessarily sequential—the steps could be performed in a variety of combinations.

Finally, at block 608, at least one of the first group and the second group is regrouped into a third group, where the third group is formed based on one of the first group and the second group. Thus, the regrouping is based on groups and not on entities such as rows, as might be the case in a typical database environment. This process might be performed again to regroup or not, as block 610 suggests. In the former case, block 610 loops back to block 600; in the latter case it stops, as block 612 indicates. In the former case then,

Although the block diagram does not expressly depict this, as already mentioned with respect to FIG. 5 and the preceding disclosure, a first grouping expression can be used to group the first group, and a second grouping expression can be used to group the second group. Moreover, the regrouping can be performed using a regrouping expression, where the regrouping expression can use a regrouping aggregate. It is also understood, that the first aggregate function can be the same as the second aggregate function. For example, both of these functions can be summations of their respective groups.

The presently disclosed subject matter can also be implemented in a computer readable medium, such as a magnetic disk, a CD, a DVD, a jump drive, or just about any memory device. It should be noted that FIG. 6 can also be implemented in a computer readable medium. FIG. 7, thus, presents yet another alternative, exemplary, and non-limiting implementation. At block 700, data is grouped into a first group. At block 702, the first group is aggregated. At block 704, the first group is regrouped into a second group, where the regrouping uses a regrouping expression. Finally, block 706 shows that the second group is regrouped again. Such regrouping can go on indefinitely, as those of skill in the art will readily appreciate. Moreover, as an ancillary matter, blocks 704A, 704B, and 704C, illustrate that the regrouping expression can be based on a group of the same scope as the first group, a group of a different scope than the first group, a scalar value, respectively—or any combination thereof (in fact, just about on any logical expression).

Lastly, while the present disclosure has been described in connection with the preferred aspects, as illustrated in the various figures, it is understood that other similar aspects may be used or modifications and additions may be made to the described aspects for performing the same function of the present disclosure without deviating therefrom. For example, in various aspects of the disclosure, grouping and regrouping using aggregation was discussed. However, other equivalent mechanisms to these described aspects are also contemplated by the teachings herein. Therefore, the present disclosure should not be limited to any single aspect, but rather construed in breadth and scope in accordance with the appended claims.

What is claimed:

1. A system for grouping and regrouping data using aggregation, comprising:
a grouping module for grouping data into at least one group instance, wherein the grouping module groups the data using at least one grouping expression; and
a regrouping module for regrouping the at least one group instance, wherein the regrouping module regroups the at least one group instance on a group instance by group instance basis into at least one regrouped group instance, using the at least one regrouping expression.

2. The system according to claim 1, wherein the regrouping expression uses at least one aggregate.

3. The system according to claim 1, wherein the regrouping module performs regrouping based in part on an aggregate computed within a group of higher scope than the at least one group instance.

4. The system according to claim 1, wherein the last one regrouping module performs regrouping based in part on an aggregate computed within a group of the same scope as the at least one group.

5. The system according to claim 1, wherein the regrouping module performs regrouping based on a scalar value.

6. The system according to claim 1, wherein the system regroups the at least one regrouped group instance.

7. The system according to claim 1, wherein the regrouped data is further grouped to form a hierarchy of groups.

8. A method for grouping and regrouping data in a database using aggregation, comprising:
grouping a first data into a first group in order to configure the first group into a first data set on which a first aggregate function can be performed;
grouping a second data into a second group in order to configure the second group into a second data set on which a second aggregate function can be performed;
performing the first aggregate function on the first data set;
performing the second aggregate function on the second data set; and
regrouping at least one of the first group and the second group into a third group, wherein the third group is formed based on one of the first group and the second group.

9. The method according to claim 8, further comprising of using a first grouping expression to group the first group.

10. The method according to claim 8, further comprising of using a second grouping expression to group the second group.

11. The method according to claim 8, wherein the regrouping is performed using a regrouping expression.

12. The method according to claim 11, wherein the regrouping expression uses a regrouping aggregate.

13. The method according to claim 8, further comprising of configuring the first aggregate function to be the same as the second aggregate function.

14. The method according to claim 8, wherein the regrouping regroups both the first group and the second group into the third group.

15. The method according to claim 8, wherein the third group is regrouped again into a fourth group.

16. The method according to claim 15, wherein the fourth group is formed using a regrouping expression.

17. A computer readable medium bearing executable instructions for grouping and regrouping data in a database using aggregation, comprising:
grouping data into a first group;
aggregating the first group; and
regrouping the first group into a second group, wherein the regrouping uses a regrouping expression.

18. The computer readable medium according to claim 17, further comprising regrouping the second group.

19. The computer readable medium according to claim 17, wherein the regrouping expression is based on a group of the same scope as the first group.

20. The computer readable medium according to claim 17, wherein the regrouping expression is based on a group of a different scope than the first group.
